(19) United States
(12) Patent Application Publication
(10) Pub. No.: US 2013/0235623 A1
(43) Pub. Date: Sep. 12, 2013

(54) TWO-SWITCH FLYBACK POWER CONVERTERS

(71) Applicant: SYSTEM GENERAL CORP., Taipei Hsien (TW)

(72) Inventor: WEI-HSUAN HUANG, TAOYUAN COUNTY 330 (TW)

(73) Assignee: SYSTEM GENERAL CORP., TAIPEI HSIEN (TW)

(21) Appl. No.: 13/790,168

(22) Filed: Mar. 8, 2013

Related U.S. Application Data
(60) Provisional application No. 61/609,572, filed on Mar. 12, 2012.

(51) Int. Cl. H02M 3/156

(52) U.S. Cl. CPC H02M 3/156
USPC 363/21.17

(57) ABSTRACT

A two-switch Flyback power converter is disclosed. The two-switch Flyback power converter comprises a transformer, a first switch, a second switch, and a control circuit. The transformer includes a primary-winding and a secondary-winding. The primary-winding has a first winding and a second winding. The first switch is coupled to switch the first winding. The second switch is coupled to switch the first winding and the second winding. The control circuit generates a first-drive signal and a second-drive signal to control the first switch and the second switch for switching the transformer and regulating an output of the two-switch Flyback power converter. The two-switch Flyback power converter with less capacitance of the bulk capacitor or bulk capacitor-less can reduce the voltage ripples at the output voltage for cost saving.

### REFERENCE TO RELATED APPLICATION

This application is based on Provisional Application Ser. No. 61/609,572, filed 12 Mar. 2012, currently pending.

### BACKGROUND OF THE INVENTION

1. Field of Invention

The present invention relates to a power converter, and more particularly, the present invention relates to a two-switch Flyback power converter.

2. Description of Related Art

FIG. 1 shows a traditional Flyback topology of power converters. A transformer T₁ includes a primary-winding N_{P} and a secondary-winding N_{S}. A first terminal of the primary-winding N_{P} is coupled to receive a DC input voltage V_{IN}. The secondary-winding N_{S} generates an output voltage V_{O} via a rectifier D_{O} and a capacitor C_{O}. A drain terminal of a power switch M is coupled to a second terminal of the primary-winding N_{P}. A sense resistor R_{S} is coupled between a source terminal of the power switch M and a ground. A switching current I_{P} flows through the primary-winding N_{P} and the power switch M when the power switch M is turned on. The sense resistor R_{S} is used to generate a current-sense signal V_{C} in response to the switching current I_{P}. In order to regulate the output voltage V_{O}, a control circuit 20 generates a drive signal V_{G} to control the power switch M for switching the transformer T₁ in response to the current-sense signal V_{C} and a feedback signal V_{FB}.

A bulk capacitor C_{huge} providing the DC input voltage V_{IN} is located between a power source V_{AC} and a bridge rectifier 10. The bulk capacitor C_{huge} connected from an output terminal of the bridge rectifier 10 to the ground is for stabilizing the DC input voltage V_{IN} at the output terminal of the bridge rectifier 10 connected to the Flyback topology.

In recent years, the size and cost problem of the bulk capacitor in switching power converters has drawn much attention. In addition, the quality of the bulk capacitor influences the usage life of the power converters. Therefore, it has become a major concern to lower or eliminate the capacitance of the bulk capacitor.

### BRIEF SUMMARY OF THE INVENTION

The object of the present invention is to provide a two-switch Flyback power converter. The two-switch Flyback power converters with less capacitance of the bulk capacitor or bulk capacitor-less can reduce the voltage ripples at the output voltage for cost saving.

A two-switch Flyback power converter according to the present invention comprises a transformer, a first switch, a second switch, and a control circuit. The transformer includes a primary-winding and a secondary-winding. The primary-winding is coupled to a power source of the two-switch Flyback power converter and has a first winding and a second winding. The first switch is coupled to switch the first winding. The second switch is coupled to switch the first winding and the second winding. The control circuit generates a first-drive signal and a second-drive signal to control the first switch and the second switch for switching the transformer and regulating an output of the two-switch Flyback power converter. The first switch and the second switch can deliver more power in a valley of the rectified power source by switching different winding to improve ripples of an output voltage of the two-switch Flyback power converter.

### BRIEF DESCRIPTION OF ACCOMPANIED DRAWINGS

The accompanying drawings are included to provide further understanding of the invention, and are incorporated into and constitute a part of this specification. The drawings illustrate embodiments of the invention and, together with the description, serve to explain the principles of the invention.

FIG. 1 shows a traditional topology of power converters.

FIG. 2 shows a circuit diagram of an embodiment of two-switch Flyback power converters according to the present invention.

FIG. 3 shows a circuit diagram of an embodiment of a control circuit according to the present invention.

FIG. 4 shows the waveforms of the power source, the high-voltage signal, the first-drive signal and the second-drive signal according to the present invention.

FIG. 5 shows a circuit diagram of another embodiment of the two-switch Flyback power converters according to the present invention.

FIG. 6 shows the waveforms of the power source, the high-voltage signal, the first-drive signal and the second-drive signal according to the present invention.

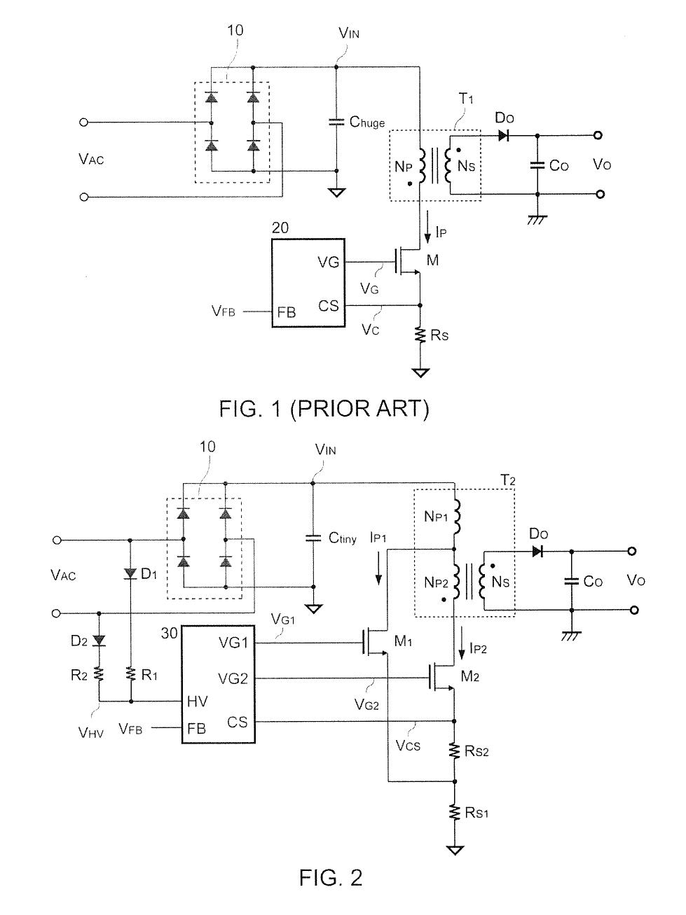

### DETAILED DESCRIPTION OF EMBODIMENTS

FIG. 2 is a circuit diagram of an embodiment of two-switch Flyback power converters according to the present invention. A rectifier can be a full-wave rectifier having a first diode D₁ and a second diode D₂ according to one embodiment of the present invention, anodes of the first diode D₁ and the second diode D₂ are connected to the power source V_{AC}. respectively. Cathodes of the first diode D₁ and the second diode D₂ are together connected to a high-voltage terminal HV of a control circuit 30 through a first-series resistor R₁ and a second-series resistor R₂. A high-voltage signal V_{HV} is generated at the high-voltage terminal HV through the full-wave rectification of the first diode D₁ and the second diode D₂. Thus, the rectifier is coupled to the power source V_{AC} for rectifying the power source V_{AC} to generate the high-voltage signal V_{HV}. The bridge rectifier 10 including a plurality of diodes rectifies the power source V_{AC} to generate the input voltage V_{IN}. A bulk capacitor C_{tiny} with less capacitance coupled from the output terminal of the bridge rectifier 10 to the ground is for stabilizing the input voltage V_{IN} at the output terminal of the bridge rectifier 10.

The two-switch Flyback power converter comprises a transformer T₂ including a primary-winding and a secondary-winding Ns. The secondary-winding Ns generates the output voltage V_{O} via the rectifier D_{O} and the capacitor C_{O}. The rectifier D_{O} is coupled between a terminal of the secondary-winding Ns and an output terminal of the two-switch Flyback power converter. The capacitor C_{O} is coupled to the output terminal of the two-switch Flyback power converter.

The primary-winding includes a first winding N_{P1} and a second winding N_{P2}. The first winding N_{P1} is coupled to the second winding N_{P2} in series. A first terminal of the first winding N_{P1} is coupled to the input voltage V_{IN}. Therefore, the primary-winding is coupled to the power source V_{AC} through the bridge rectifier 10. A drain terminal of a first switch M₁ is coupled to a second terminal of the first winding N_{P1} and a first terminal of the second winding N_{P2}. A first-switching current I_{P1} flowing through the first winding N_{P1} is generated at the drain terminal of the first switch M₁. An output terminal VG1 of the control circuit 30 generates a first-drive signal V_{G1} supplied to a gate terminal of the first switch M₁. The first-drive signal V_{G1} controls the first switch M₁ to switch the first winding N_{P1} of the transformer T₂ for regulating the output voltage V_{O} of the two-switch Flyback power converter.

A sense circuit includes a first-sense resistor R_{S1} and a second-sense resistor R_{S2}. The first-sense resistor R_{S1} is coupled between a source terminal of the first switch M₁ and the ground. A drain terminal of a second switch M₂ is coupled to a second terminal of the second winding N_{P2}. A second-switching current I_{P2} flowing through the second winding N_{P2} is generated at the drain terminal of the second switch M₂. An output terminal VG2 of the control circuit 30 generates a second-drive signal V_{G2} supplied to a gate terminal of the second switch M₂. The second-drive signal V_{G2} controls the second switch M₂ to switch the first winding N_{P1} and the second winding N_{P2} of the transformer T₂ for regulating the output voltage V_{O} of the two-switch Flyback power converter. The first switch M₁ and the second switch M₂ are power switches according to one embodiment of the present invention. The second-sense resistor R_{S2} is coupled between a source terminal of the second switch M₂ and the first-sense resistor R_{S1}. A current-sense signal V_{CS} is generated at the second-sense resistor R_{S}, and the source terminal of the second switch M₂ coupled to a current-sense terminal CS of the control circuit 30 in response to the second-switching current I_{P2}.

The control circuit 30 generates the first-drive signal V_{G1} and the second-drive signal V_{G2} to regulate the output of the two-switch Flyback power converter in response to the high-voltage signal V_{HV}, the current-sense signal V_{CS}, and a feedback signal V_{FB}. The feedback signal V_{FB} is obtained at a feedback terminal FB of the control circuit 30 by detecting the output voltage V_{O}. The feedback signal V_{FB} is correlated to the output voltage V_{O}.

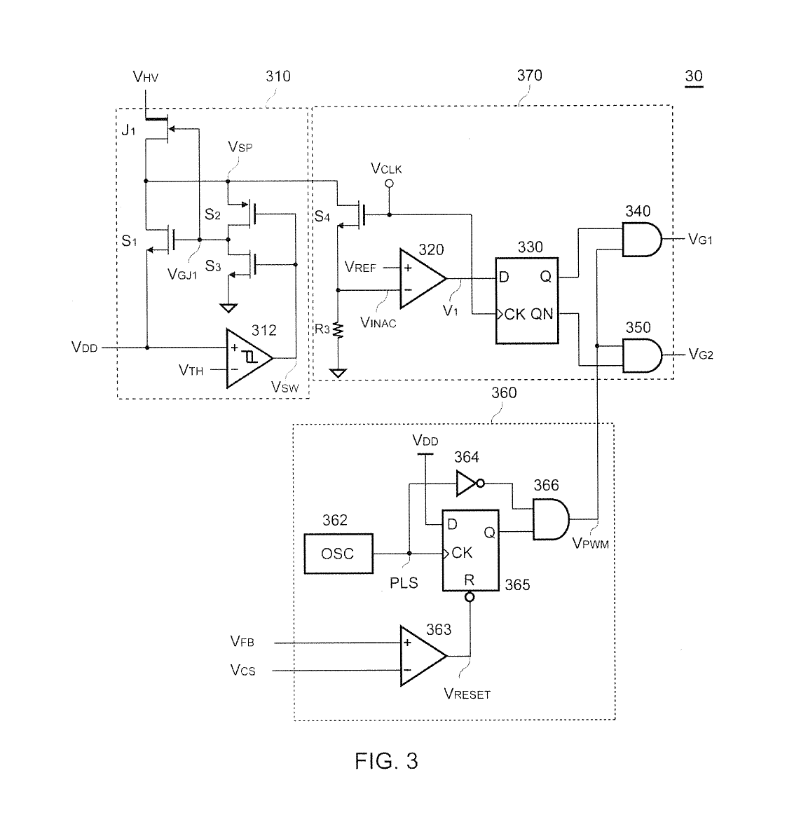

FIG. 3 shows a circuit diagram of an embodiment of the control circuit according to the present invention. The control circuit 30 comprises a detection circuit 310, a PWM circuit 360, and a switch circuit 370. The detection circuit 310 includes a high-voltage switch J₁, a first transistor S a second transistor S₂, a third transistor S₃ and a hysteresis comparator 312. The detection circuit 310 is coupled to the series resistors R₁ and R₂ for detecting the high-voltage signal V_{HV} to generate a sample signal V_{SP}. Therefore, the detection circuit 310 detects the power source V_{AC} (as shown in FIG. 2) for generating the sample signal V_{SP} through detecting the high-voltage signal V_{HV}. The high-voltage switch J₁ formed by a Junction Field Effect Transistor (JFET) has a drain terminal coupled to the series resistors R₁ and R₂ for receiving the high-voltage signal V_{HV}. The drain terminal of the high-voltage switch J₁ is further coupled to the power source V_{AC} through the series resistors R₁ and R₂, the diodes D₁ and D₂.

The first transistor S₁ has a drain terminal coupled to a source terminal of the high-voltage switch a gate terminal coupled to a gate terminal of the high-voltage switch J₁. The sample signal V_{SP} is generated at the source terminal of the high-voltage switch J₁ and the drain terminal of the first transistor S₁. The sample signal V_{SP} is correlated to the high-voltage signal V_{HV}. A trigger signal V_{GJ1} is generated at the gate terminals of the high-voltage switch J₁ and the first transistor S₁. The second transistor S₂ has a drain terminal coupled to the gate terminals of the high-voltage switch J₁ and the first transistor S₁, a source terminal coupled to the source terminal of the high-voltage switch J₁ and the drain terminal of the first transistor S₁ for receiving the sample signal V_{SP}. The third transistor S₃ has a drain terminal coupled to the drain terminal of the second transistor S₂ and the gate terminals of the high-voltage switch J₁ and the first transistor S₁ for receiving the trigger signal V_{GJ1}, a source terminal that is coupled to the ground, a gate terminal coupled to a gate terminal of the second transistor S₂.

A positive input terminal of the hysteresis comparator 312 is coupled to a source terminal of the first transistor S₁ for receiving a supply voltage V_{DD}. The hysteresis comparator 312 has a negative input terminal to receive a threshold signal V_{TH}. An output terminal of the hysteresis comparator 312 generates a switching signal V_{SW} that is coupled to the gate terminals of the second transistor S₂ and the third transistor S₃. By comparing the supply voltage V_{DD} with the threshold signal V_{TH}, the switching signal V_{SW} is generated and controls an on/off status of the second transistor S₂ and the third transistor S₃. The hysteresis comparator 312 is only one embodiment of the present invention, and the prevent invention isn't limited to the hysteresis comparator 312.

In this manner, the switching signal V_{SW} is at a high-level once the supply voltage V_{DD} is larger than an upper-limit of the threshold signal V_{TH}. On the contrary, the switching signal V_{SW} is at a low-level once the supply voltage V_{DD} is smaller than a lower-limit of the threshold signal V_{TH}. The lower-limit of the threshold signal V_{TH} is also called an under voltage lockout (UVLO). Because of the hysteresis characteristic of the hysteresis comparator 312, the difference between the upper-limit and the lower-limit always keeps a fixed voltage range.

When the power source V_{AC} is switched on, the drain terminal of the high-voltage switch J₁ receiving the high-voltage signal V_{HV} is turned on immediately. The switching signal V_{SW} is at the low-level since the supply voltage V_{DD} hasn't been created yet. At this time, the third transistor S₃ is turned off and the second transistor S₂ is turned on. The sample signal V_{SP} is about a threshold voltage of the second transistor S₂ and generated at the source terminal of the high-voltage switch J₁ and the drain terminal of the first transistor S₁. Because the second transistor S₂ is turned on, the trigger signal V_{GJ1} is the same as the sample signal V_{SP} and generated at the gate terminals of the high-voltage switch J₁ and the first transistor S₁.

In the meantime, the first transistor S₁ is turned on and the supply voltage V_{DD} is charged by the high-voltage signal V_{HV}. The first transistor S₁ serves as a charge transistor for charging the supply voltage V_{DD}. When the supply voltage V_{DD} reaches to the upper-limit of the threshold signal V_{TH}, the switching signal V_{SW} is at the high-level. At this time, the third transistor S₃ is turned on and the second transistor S₂ is turned off. Because the trigger signal V_{GJ1} is pulled down to the ground, the first transistor S₁ is turned off and the gate terminal of the high-voltage switch J₁ is at a low-level. During a short period, the source-to-gate voltage of the high-voltage switch J₁ will be higher than a threshold and the high-voltage switch J₁ is turned off.

The switch circuit 370 includes a fourth transistor S₄, a pull-down resistor R₃, a voltage comparator 320, a flip-flop 330, a first AND gate 340 and a second AND gate 350. The fourth transistor S₄ has a drain terminal coupled to the detection circuit 310 for receiving the sample signal V_{SP}, and a source terminal coupled to one terminal of the pull-down resistor R₃ for generating an input signal V_{INAC}. The other terminal of the pull-down resistor R₃ is coupled to the ground. A gate terminal of the fourth transistor S₄ is coupled to receive a clock signal V_{CLK}. The fourth transistor S₄ is turned on once the clock signal V_{C1} is at a high-level. Because of the voltage drop in the pull-down resistor R₃, the source-to-gate voltage of the high-voltage switch J₁ will be lower than the threshold and the high-voltage switch J₁ is turned on. On the other hand, the high-voltage switch J₁ is turned off once the clock signal V_{CLK} is at a low-level.

The voltage comparator 320 has a positive input terminal receiving a reference signal V_{REF}, and a negative input terminal coupled to the source terminal of the fourth transistor S₄ for receiving the input signal V_{INAC}. The input signal V_{INAC} is proportional to the high-voltage signal V_{HV} and correlated to the sample signal V_{SP} once the high-voltage switch J₁ and the fourth transistor S₄ are turned on. A clock input terminal CK of the flip-flop 330 coupled to the gate terminal of the fourth transistor S₄ receives the clock signal V_{CLK}. An input terminal D of the flip-flop 330 coupled to an output terminal of the voltage comparator 320 receives a first signal V₁. The first signal V₁ is generated by comparing the input signal V_{INAC} with the reference signal V_{REF}. As mentioned above, the voltage comparator 320 is utilized for generating the first signal V₁ in response to the sample signal V_{SP} and the reference signal V_{REF}.

The PWM circuit 360 includes an oscillator (OSC) 362, a PWM comparator 363, an inverter 364, a flip-flop 365 and an AND gate 366. The oscillator 362 generates a pulse signal PLS. A positive input terminal of the PWM comparator 363 receives the feedback signal V_{FB}. The current-sense signal V_{CS} is supplied to a negative input terminal of the PWM comparator 363. The feedback signal V_{FB} is correlated to the output voltage V_{O} (as shown in FIG. 2), and the current-sense signal V_{CS} is correlated to the second-switching current I_{P2} (as shown in FIG. 2). The flip-flop 365 has an input terminal D receiving a supply voltage V_{CC}, a clock-input terminal CK receiving the pulse signal PLS, a reset-input terminal R receiving a reset signal V_{RESET}. The reset signal V_{RESET} is generated when the current-sense signal V_{CS} is larger than the feedback signal V_{FB}. A first input terminal of the AND gate 366 coupled to the oscillator 362 receives the pulse signal PLS through the inverter 364. A second input terminal of the AND gate 366 is coupled to an output terminal Q of the flip-flop 365. A PWM signal V_{PWM} is generated at an output terminal of the AND gate 366.

A first input terminal of the first AND gate 340 is coupled to an output terminal Q of the flip-flop 330. The PWM signal V_{PWM} is supplied to a second input terminal of the first AND gate 340 and a first input terminal of the second AND gate 350. A second input terminal of the second AND gate 350 is coupled to an output terminal QN of the flip-flop 330. The first-drive signal V_{G1} and the second-drive signal V_{G2} are generated at the output terminals of the first AND gate 340 and the second AND gate 350, respectively.

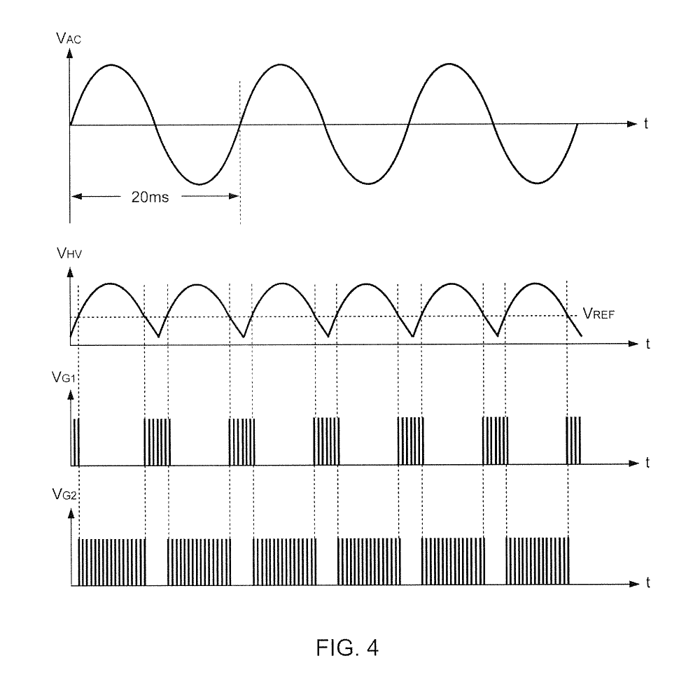

FIG. 4 shows the waveforms of the power source V_{AC}, the high-voltage signal V_{HV}, the first-drive signal V_{G1} and the second-drive signal V_{G2} according to the present invention. The period of the power source V_{AC} is about 20 ms if the input supply frequency of the power source V_{AC} is 50 Hz. The high-voltage signal V_{HV} is generated through the full-wave rectification of the first diode D₁ and the second diode D₂ (as shown in FIG. 2). As shown in FIG. 3 the clock signal V_{CLK} is used to control the fourth transistor S₄ for sampling the high-voltage signal V_{HV}.

When the high-voltage signal V_{HV} is higher than the reference signal V_{REF}, the first-drive signal V_{G1} will be disabled and the second-drive signal V_{G2} will be enabled. Therefore, the first switch M₁ will be turned off and the second switch M₂ will start high-frequency switching. Once the high-voltage signal V_{HV} is lower than the reference signal V_{REF}, the second-drive signal V_{G2} will be disabled and the first-drive signal V_{G1} will be enabled. Therefore, the second switch M₂ is turned off and the first switch M₁ will start high-frequency switching. According to above, the first switch M₁ will start switching and the second switch M₂ will be turned off when the power source V_{AC} is lower than a threshold such as the reference signal V_{REF}. The second switch M₂ will start switching and the first switch M₁ will be turned off when the power source V_{AC} is higher than the threshold. In other words, the control circuit 30 is utilized to detect whether the power source V_{AC} drops off to the valley of the power source V_{AC} that is rectified, such as the valley of the high-voltage signal V_{HV} or the input voltage V_{IN}. The control circuit 30 drives the first switch M₁ in a first operating mode when the power source V_{AC} is lower than the threshold, and the control circuit 30 drives the second switch M₂ in a second operating mode when the power source V_{AC} is higher than the threshold.

Referring to FIG. 2, when the first switch M₁ is switching, the turn ratio of the primary-winding to the secondary-winding Ns (the winding turns of the first winding N_{P1} to the winding turns of the secondary-winding Ns) is a low level, the first-switching current I_{P1} is a high level, and a lower resistance of the sense circuit (the first-sense resistor R_{S1}) is determined. When the second switch M₂ is switching, the turn ratio of the primary-winding to the secondary-winding Ns (the winding turns of the first winding N_{P1} and the second winding N_{P2} to the winding turns of the secondary-winding Ns) is a high level, the second-switching current I_{P2} is a low level, and a higher resistance of the sense circuit (the first-sense resistor R_{S1} and the second-sense resistor R_{S2}) is determined. Therefore, the switches M₁ and M₂ can deliver more power in the valley of the rectified power source, such as the valley of the high-voltage signal V_{HV} or the input voltage V_{IN}, by switching different winding or adjusting a turn ratio of the primary-winding to improve the ripples of the output voltage V_{O}.

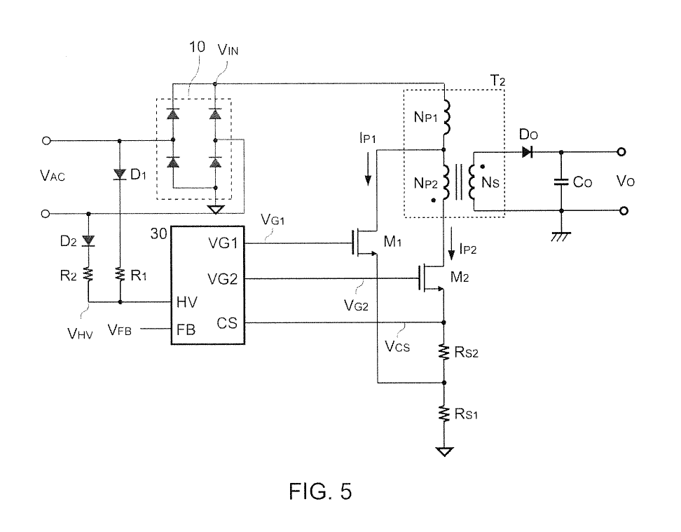

If the power converters using Flyback topology don't have the bulk capacitor, the large ripples will be generated at the output voltage V_{O} when the power source V_{AC} drops to the valley of the rectified power source. During the valley of the rectified power source, the power source V_{AC} stays a lower voltage and lasts a short period. According to the present invention, the two-switch Flyback power converters with less capacitance of the bulk capacitor C_{tiny} (as shown in FIG. 2) or bulk capacitor-less (as shown in FIG. 5) can reduce the voltage ripples at the output voltage V_{O} by adding another switch M₂ such as MOSFET. Since the cost of MOSFET is much cheaper than the bulk capacitor, the two-switch Flyback power converters can save total BOM cost.

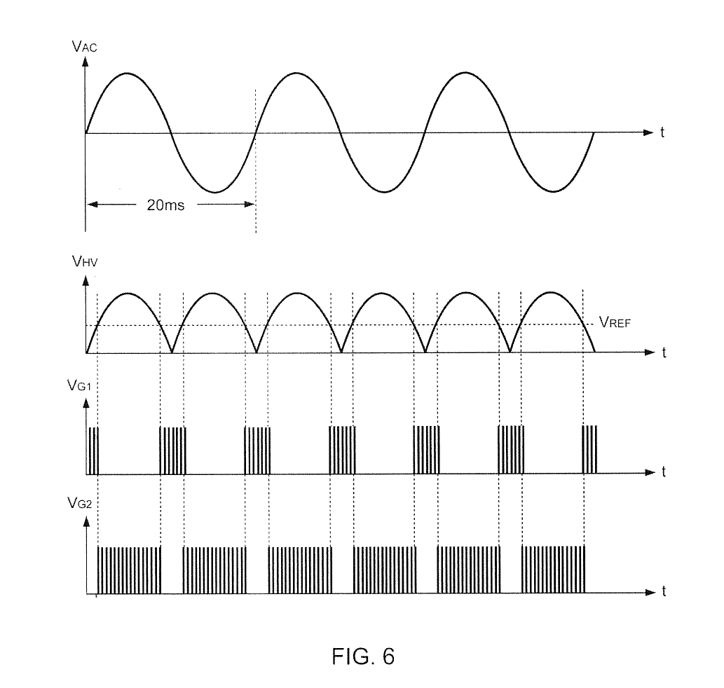

FIG. 6 shows the waveforms of the power source V_{AC}, the high-voltage signal V_{HV}, the first-drive signal V_{G1} and the second-drive signal V_{G2} according to the two-switch Flyback power converter without bulk capacitor shown the FIG. 5. When the high-voltage signal V_{HV} is higher than the reference signal V_{REF}, the first-drive signal V_{G1} will be disabled and the second-drive signal V_{G2} will be enabled. Therefore, the first switch M₁ (as shown in FIG. 5) will be turned off and the second switch M₂ (as shown in FIG. 5) will start high-frequency switching. Once the high-voltage signal V_{HV} is lower than the reference signal V_{REF}, the second-drive signal V_{G2} will be disabled and the first-drive signal V_{G1} will be enabled. Therefore, the second switch M₂ is turned off and the first switch M₁ will start high-frequency switching. The two-switch Flyback power converter can reduce the voltage ripples at the output voltage V_{O} by switching different winding or adjusting a turn ratio of the primary-winding even if the two-switch Flyback power converter has a smaller bulk capacitor or lacks the bulk capacitor C_{tiny}.

Although the present invention and the advantages thereof have been described in detail, it should be understood that various changes, substitutions, and alternations can be made therein without departing from the spirit and scope of the invention as defined by the appended claims. That is, the discussion included in this invention is intended to serve as a basic description. It should be understood that the specific discussion may not explicitly describe all embodiments possible; many alternatives are implicit. The generic nature of the invention may not fully explained and may not explicitly show that how each feature or element can actually be representative of a broader function or of a great variety of alternative or equivalent elements. Again, these are implicitly included in this disclosure. Neither the description nor the terminology is intended to limit the scope of the claims.

What is claimed is:

1. A two-switch Flyback power converter, comprising:
a transformer including a primary-winding and a secondary-winding, the primary-winding having a first winding and a second winding, the primary-winding coupled to a power source of the two-switch Flyback power converter;
a first switch coupled to switch the first winding;
a second switch coupled to switch the first winding and the second winding; and
a control circuit generating a first-drive signal and a second-drive signal to control the first switch and the second switch for switching the transformer and regulating an output of the two-switch Flyback power converter, wherein the first switch and the second switch can deliver more power in a valley of the power source, which is rectified, by switching different winding to improve ripples of an output voltage of the two-switch Flyback power converter.

2. The power converter as claimed in claim 1, wherein a turn ratio of the primary-winding to the secondary-winding is a low level and a switching current flowing through the first winding is a high level when the first switch is switching and the second switch is turned off.

3. The power converter as claimed in claim 1, wherein a turn ratio of the primary-winding to the secondary-winding is a high level and a switching current flowing through the second winding is a low level when the second switch is switching and the first switch is turned off.

4. The power converter as claimed in claim 1, further comprising a sense circuit coupled to the first switch and the second switch, wherein a lower resistance of the sense circuit is determined when the first switch is switching and the second switch is turned off, and a higher resistance of the sense circuit is determined when the second switch is switching and the first switch is turned off.

5. The power converter as claimed in claim 4, wherein the sense circuit includes a first-sense resistor and a second-sense resistor, the first-sense resistor is coupled to the first switch, and the second-sense resistor is coupled to the second switch.

6. The power converter as claimed in claim 1, wherein the control circuit comprises:
a switch circuit generating the first-drive signal and the second-drive signal in response to a PWM signal and a sample signal;
a PWM circuit generating the PWM signal in response to a feedback signal and a current-sense signal; and
a detection circuit detecting the power source for generating the sample signal;
wherein the feedback signal is correlated to the output of the two-switch Flyback power converter, and the current-sense signal is correlated to a switching current flowing through the primary-winding.

7. The power converter as claimed in claim 1, wherein the first switch and the second switch can deliver more power in the valley of the rectified power source by adjusting a turn ratio of the primary-winding to improve ripples of the output voltage of the two-switch Flyback power converter.

8. The power converter as claimed in claim 1, wherein the first switch will start switching and the second switch will be turned off when the power source is lower than a threshold.

9. The power converter as claimed in claim 1, wherein the second switch will start switching and the first switch will be turned off when the power source is higher than a threshold.

10. A circuit, comprising:
a transformer including a primary-winding and a secondary-winding, the primary-winding having a first winding and a second winding, the primary-winding coupled to a power source of a power converter;
a first switch coupled to switch the first winding;
a second switch coupled to switch the first winding and the second winding; and
a control circuit coupled to the power source of the power converter, wherein the control circuit is coupled to detect whether the power source drops off to a valley of the power source that is rectified, the control circuit is coupled to drive the first switch in a first operating mode when the power source is lower than a threshold, and the control circuit is coupled to drive the second switch in a second operating mode when the power source is higher than the threshold.
